(19) United States
(12) Patent Application Publication
(10) Pub. No.: US 2025/0384383 A1
(43) Pub. Date: Dec. 18, 2025

(54) SYSTEM AND METHOD OF MANAGING OPERATIONS IN A WAREHOUSE

(71) Applicant: Honeywell International Inc., Charlotte, NC (US)

(72) Inventors: Anish Chakrabarti, Cincinnati, OH (US); Amruta Tripathy, Bangalore (IN); Ananda Vel Murugan Chandra Mohan, Madurai (IN); Siva kumar Reddy Patil, Bangalore (IN); Hardik Agarwal, Siliguri (IN); Kavana N V, Bangalore (IN); Soham Banerjee, Bangalore (IN)

(21) Appl. No.: 18/743,125

(22) Filed: Jun. 14, 2024

(51) Int. Cl. G06Q 10/08; G06Q 10/0631

(52) U.S. Cl. CPC G06Q 10/08; G06Q 10/063112

(57) ABSTRACT

A system and a method of managing operations in a warehouse is described. The method comprises receiving, from sensors installed at one or more locations in the warehouse, sensor information related to events occurring within the warehouse in a real-time. The events are associated with performance of assets responsible for movement of articles within the warehouse. The sensor information is mapped with one or more assets present in the warehouse, using a process model of the warehouse. A first anomaly in an event is identified based on violation of predefined limits set for the sensor information related to the event. A plurality of scenarios is simulated based on the sensor information, to identify effect of the anomaly on the movement of the articles and to determine one or more recommendations for mitigating the effect of the first anomaly. An operator is notified about the one or more recommendations.

### TECHNICAL FIELD

Present disclosure relates to a system and a method of managing operations in a warehouse, and particularly, relates to management of operations through usage of data from different sources and providing recommendations for mitigating anomalies in a real-time.

### BACKGROUND

Material distribution centers or warehouses are hubs for storage and transfer of various goods, such as the ones supplied from industries or over e-commerce supply chains. A warehouse typically includes different areas for retrieval, storage, and dispatch of the goods. Movement of the articles across such areas is done with help of individuals and machineries. Malfunction of any machinery or improper allocation of manpower for handling any task within the warehouse can create an imbalance in a demand-supply chain and thus result into significant business losses. Therefore, a warehouse management solution offering management of manpower and machine operations in a warehouse is generally required for ensuring smooth operations in a warehouse.

Conventional warehouse management solutions provide sensor information related to operation of machines in a warehouse, after occurrence of undesired events. Such sensor information is used for analysis to perform maintenance operations, specifically to determine potential solutions that could be implemented in future to prevent occurrence of the undesired events. Therefore, the conventional warehouse management solutions cannot be used for managing the undesired events in a real-time. Further, the conventional warehouse management solutions do not offer usage of data from other sources and thus do not allow operational planning at different levels.

Therefore, there remains a need of a solution for real-time and efficient management of operations in a warehouse.

### SUMMARY OF THE INVENTION

The present invention relates to a system and a method of managing operations in a warehouse. The method comprises receiving, from sensors installed at one or more locations in the warehouse, sensor information related to events occurring within the warehouse in a real-time. The events are associated with performance of assets responsible for movement of articles at one or more locations in the warehouse. The sensor information may be obtained as time-series data or as data blobs. The sensor information is mapped with one or more assets present in the warehouse, using a process model of the warehouse.

Successively, a violation of predefined limits set for the sensor information related to an event may be determined. Each violation may indicate a first anomaly in the event. Thereafter, a plurality of scenarios may be simulated based on the sensor information, to identify effect of the anomaly on the movement of the articles and to determine one or more recommendations for mitigating the effect of the first anomaly. In one implementation, historical data may also be utilized for simulating the plurality of scenarios. Further, the sensor information of dependent assets may be clustered for simulating the plurality of scenarios. Additionally, an output of computation of a higher level event may be utilized for performing computation of a lower level event associated with the higher level event, for simulating the plurality of scenarios. The plurality of scenarios is simulated by referring to a knowledge base. An operator may be notified about the one or more recommendations.

The method further comprises utilizing workforce information for identifying a second anomaly in the event. The workforce information includes details of individuals designated for handling all the events in the warehouse. The second anomaly is associated with shortage or lack of skilled individuals designated for handling the event. The skilled individuals may be identified from the workforce information based on availability and skill set, for performing one or more tasks specified in the one or more recommendations.

In one implementation, scheduled calculations may be triggered at predefined time intervals upon receipt of a predefined amount of the sensor information, such as after every 15 minutes, 30 minutes or 1 hour.

In one aspect, the operator may be allowed to define a mode of communication, warehouse site, frequency, severity, and category of the events for receiving notifications related to anomalies and recommendations.

The system for managing operations in a warehouse comprises a processor and a memory storing program instructions which, when executed by the processor, causes the processor to perform several functions. The processor receives, from sensors installed at one or more locations in the warehouse, sensor information related to events occurring within the warehouse in a real-time. The events are associated with performance of assets responsible for movement of articles at one or more locations in the warehouse. The processor maps the sensor information with one or more assets present in the warehouse, using a process model of the warehouse. The processor identifies a first anomaly in an event, based on violation of predefined limits set for the sensor information related to the event. The processor simulates a plurality of scenarios, based on the sensor information, to identify effect of the first anomaly on the movement of the articles and to determine one or more recommendations for mitigating the effect of the first anomaly. The plurality of scenarios is simulated by referring to a knowledge base. The processor notifies an operator about the one or more recommendations.

A non-transitory computer-readable storage medium storing program instructions for managing operations in a warehouse is described. The instructions, when executed, perform several steps including receiving, from sensors installed at one or more locations in the warehouse, sensor information related to events occurring within the warehouse in a real-time. The events are associated with performance of assets responsible for movement of articles at one or more locations in the warehouse. The instructions further perform mapping of the sensor information with one or more assets present in the warehouse, using a process model of the warehouse. The instructions further perform identifying a first anomaly in an event, based on violation of predefined limits set for the sensor information related to the event. The instructions further perform simulating a plurality of scenarios, based on the sensor information, to identify effect of the anomaly on the movement of the articles and to determine one or more recommendations for mitigating the effect of the first anomaly. The plurality of scenarios is simulated by referring to a knowledge base. The instructions further perform notifying an operator about the one or more recommendations.

By implementing the above described methodology, the proposed system is able to provide one or more technical advantages mentioned successively. The system enables utilization of real-time sensor information of machines operating in a warehouse for managing the undesired events i.e. anomalies in a real-time. Further, data from other sources, such as Workforce Management system (WMS), Labor Management System (LMS), and Computerized Maintenance Management System (CMMS) is also utilized for identifying the anomalies in the real-time. Based on analysis of data obtained from all the sources, the system identifies the anomalies and determines suitable recommendations for fixing the anomalies. Further, the system provides, to the customers, real-time insights of operations being performed in the warehouse, deviations or anomalies in usual operations, and the ways to fix the anomalies.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a system for managing operations in a warehouse, in accordance with an embodiment of the present disclosure;

FIG. 2 illustrates a block diagram of the cloud server 104 configured to manage operations in the warehouse, in accordance with an embodiment of the present disclosure.

FIG. 3 illustrates a portion of the process model, in accordance with an embodiment of the present disclosure;

FIG. 4 illustrates a method of development of the process model, in accordance with an embodiment of the present disclosure;

FIG. 5 illustrates a snippet of asset mapping details, in accordance with an embodiment of the present disclosure;

FIG. 6 illustrates a flow chart of a method of pre-processing and storage of sensor information, in accordance with an embodiment of the present disclosure;

FIG. 7 illustrates a flow-chart of the system for generating a plurality of simulated scenarios based on a DES model, in accordance with an embodiment of the present invention.

FIG. 8 illustrates steps for simulating a plurality of scenarios occurring in a warehouse corresponding to anomalies, in accordance with an embodiment of the present disclosure;

FIG. 9 illustrates the correlation of the plurality of simulated scenarios with real time data for determining recommendations, in accordance with an embodiment of the present invention.

FIGS. 10(a), 10(b), and 10(c) illustrate tabular data relating to an exemplary implementation of the system 100 for identifying optimal and bottleneck scenarios, in accordance with an embodiment of the present invention

FIG. 11 illustrates a method of managing operations in a warehouse when an asset is already affected, in accordance with an embodiment of the present disclosure.

FIG. 12 illustrates a method of managing operations in a warehouse when an asset going to be affected, in accordance with an embodiment of the present disclosure.

FIG. 13 illustrates a method for planning operations of a warehouse, in accordance with an embodiment of the present invention.

FIG. 14 illustrate a process of creating and implementing a job, in accordance with an embodiment of the present invention.

### DETAILED DESCRIPTION OF THE INVENTION

The present disclosure provides a system and a method for managing operations in a warehouse. The system receives, from sensors installed at one or more locations in the warehouse, sensor information related to events occurring within the warehouse in a real-time. The events are associated with performance of assets responsible for movement of articles at one or more locations in the warehouse. The sensor information may be obtained as time-series data or as data blobs. The sensor information is mapped with one or more assets present in the warehouse, using a process model of the warehouse.

Successively, a violation of predefined limits set for the sensor information related to an event may be determined. Each violation may indicate a first anomaly in the event. Thereafter, a plurality of scenarios may be simulated based on the sensor information, to identify effect of the anomaly on the movement of the articles and to determine one or more recommendations for mitigating the effect of the first anomaly. The plurality of scenarios is simulated by referring to a knowledge base. An operator may be notified about the one or more recommendations.

Workforce information may also be used for identifying a second anomaly in the event. The workforce information includes details of individuals designated for handling all the events in the warehouse. The second anomaly is associated with shortage or lack of skilled individuals designated for handling the event. The skilled individuals may be identified from the workforce information based on availability and skill set, for performing one or more tasks specified in the one or more recommendations.

Multiple scenarios corresponding to different values of variables associated the anomaly is generated based on a Discrete Event Simulation (DES) model, which may thereafter be correlated with real-time data to identify possible optimal and/or bottleneck scenarios that may arise corresponding to the anomaly. The system further provides recommendations relating to managing operations in a warehouse, wherein recommendations may be based on identified bottleneck scenario and/or optimal scenario. Detailed operation of the system has been provided henceforth with reference to several figures.

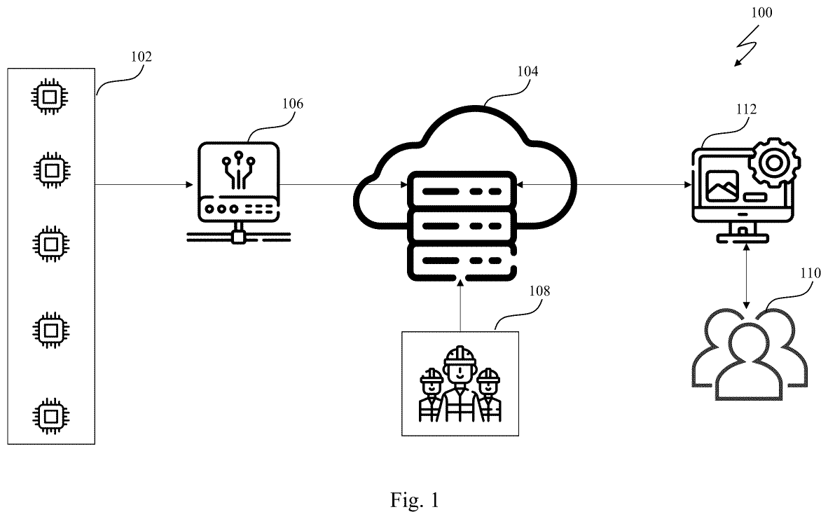

FIG. 1 illustrates a system 100 for managing operations in a warehouse, in accordance with an embodiment of the present disclosure. The system 100 includes sensors 102 of different types installed at different locations in the warehouse. The sensors 102 are used for monitoring and managing different aspects of operations running in the warehouse and play a crucial role in optimizing processes, ensuring safety, and enhancing overall efficiency. The sensors 102 may be barcode scanners for reading barcode information on products, pallets, and containers, helping in tracking items throughout the warehouse. The sensors 102 may be Radio-Frequency Identification (RFID) tag readers allowing non-line-of-sight reading and enabling multiple reads simultaneously. The sensors 102 may be Global Positioning System (GPS) tracking sensors for tracking movement of vehicles within the warehouse premises or in outdoor yards. The GPS tracking sensors provide real-time location information, improving logistics and routing efficiency.

The sensors 102 may be temperature and humidity sensors for monitoring environmental conditions to ensure that temperature-sensitive goods, such as food or pharmaceuticals, are stored within specified ranges. The sensors 102 may be proximity sensors for detecting presence or absence of objects. Proximity sensors are used in conveyor systems and Automated Guided Vehicles (AGVs) to ensure safe and efficient movement of goods and equipment. The sensors 102 may be weight sensors for measuring weight of goods on pallets or in storage areas. The weight sensors contribute to accurate inventory management and can trigger alerts if weight thresholds are exceeded. The sensors 102 may be motion sensors for detecting unauthorized movement within the warehouse. The motion sensors can trigger alarms or notifications in the case of suspicious activity. The sensors 102 may be gas and smoke detectors for detecting presence of harmful gases or smoke, triggering alarms and emergency responses to prevent accidents.

The sensors 102 may be occupancy sensors for monitoring presence of personnel in different areas of the warehouse. The occupancy sensors can be used for lighting control, optimizing energy usage in areas only occupied when necessary. The sensors 102 may be sound and vibration sensors for detecting sounds or vibrations, helping identify potential equipment malfunctions or structural issues before they become serious problems. The sensors 102 may be light sensors for managing lighting systems in warehouses. The lighting sensors can adjust artificial lighting based on natural light levels, contributing to energy efficiency. The sensors 102 may be collision detection sensors installed on vehicles like forklifts or AGVs. The collision detection sensors help prevent accidents by detecting obstacles and triggering automatic braking or alert systems.

The sensors 102 may be installed along with or in vicinity of different assets in the warehouse. Such assets may be responsible for movement of articles at one or more locations in the warehouse. The assets may include conveyors, such as belt conveyors or roller conveyors. The assets may include Automated Guided Vehicles (AGVs). The AGVs are autonomous mobile robots programmed to transport the articles within the warehouse. The AGVs can follow pre-defined paths or navigate dynamically using sensors and cameras. The assets may include forklifts and pallet jacks. The forklifts may be used for lifting and moving palletized goods within the warehouse. Electric pallet jacks that are smaller is size and more suitable for handing lighter articles can also be used. The assets may include pick-to-light and put-to-light systems. Such systems use light indicators to guide warehouse staff to a location of an article needed to be picked or placed, reducing errors and improving efficiency.

The assets may include sorting systems for separating and routing articles to their respective destinations within the warehouse. The assets may include drones and robotics for inventory counting, picking, and transportation. The assets may include packaging and labelling systems for preparing the articles for shipment quickly and accurately. Implementing a combination of such assets allow the warehouses to create efficient and automated processes, leading to improved accuracy, speed, and overall operational effectiveness. The choice of hardware depends on the specific requirements, size, and nature of warehouse operations.

The sensors 102 may capture sensor information, related to events occurring within the warehouse, in a real-time. The events are associated with performance/operation of the assets. For example, a faulty status of a conveyor would be indicated by the sensor information captured by a sensor integrated with the conveyor. The sensor information may be communicated to a cloud server 104 over a computer network, through a gateway controller 106. The gateway controller 106 may streamline and transform the sensor information to a proprietary or predefined data format before forwarding to the cloud server 104. Transformation of the sensor information may be required for understanding and performing required operations at the cloud server 104.

For transformation of the sensor information, the gateway controller 106 may perform protocol conversion. When the cloud server 104 uses a communication protocol different from the one used by the sensors 102, the gateway controller 106 may perform protocol conversion. The protocol conversion would ensure seamless communication between the sensors 102 and the cloud server 104. The gateway controller 106 may also implement security measures to protect the sensor information, such as through application of encryption and authentication techniques. Transformation of the sensor information by the gateway controller 106 may optimize efficiency, reduce bandwidth usage, or meet other specific requirements.

The cloud server 104 may also receive workforce information from a Workforce Management System (WMS) 108. The workforce information may include details of individuals designated for handling all the events in the warehouse. The cloud server 104 may perform analytics operations on the sensor information and the workforce information to determine an anomaly in an event or an anomaly associated with shortage or lack of skilled individuals designated for handling the event respectively. Thereafter, the cloud server 104 may simulate a plurality of scenarios to identify effect of the one or more anomalies on the movement of the articles. The cloud server 104 may also determine one or more recommendations for mitigating the effect of the one or more anomalies. The plurality of scenarios is simulated and the one or more recommendations are determined by referring to a knowledge base. The knowledge base may be present within the cloud server 104.

The knowledge base may include a variety of information required for simulating the plurality of scenarios. For example, the knowledge base may be a document management system used for centralizing documents and files, making it easy to organize, store, and retrieve various types of documents, such as manuals, guides, and policies. The knowledge base may be an internal knowledge base storing information specific to a warehouse, such as internal policies, procedures, and best practices. The knowledge base may be a training and Learning Management System (LMS) used for training purposes, containing educational materials, courses, and resources for employee training and development. The knowledge base may be a legal knowledge base storing legal documents, case laws, regulations, and other legal information related to the warehouse and the resources working on the warehouse.

The knowledge base may be an Information Technology (IT) knowledge Base storing information related to IT systems, software, hardware, troubleshooting guides, and best practices. The knowledge base may be a product knowledge base storing information about a specific product, including user manuals, specifications, and updates. The knowledge base may be a Geographic Information System (GIS) storing spatial data, maps, and geographic information. The knowledge base may be a government knowledge base storing information related to government policies, laws, regulations, and administrative procedures.

The cloud server 104 may provide an outcome of the analytics operations i.e. details of the anomaly and the one or more recommendations to an operator 110 through a user device 112, wherein the recommendations may be generated based identification of one or more bottleneck scenarios and/or optimal scenarios. Such outcome of the analytics operations may be presented over a dashboard and accessed by the operator 110 based on access rights. Referring to the one or more recommendations, the operator 110 may take suitable actions in the real-time for addressing the anomaly.

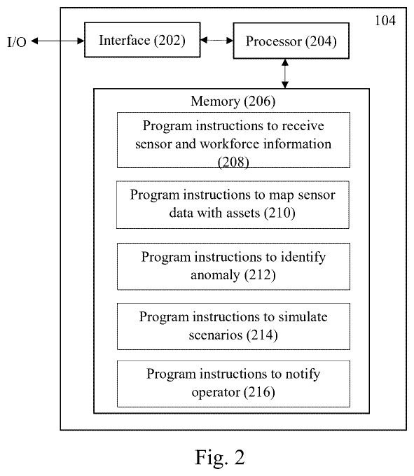

FIG. 2 illustrates a block diagram of the cloud server 104 configured to manage operations in the warehouse, in accordance with an embodiment of the present disclosure. The cloud server 104 may comprise an interface 202, a processor 204, and a memory 206. The memory 206 may store program instructions for performing several functions through which operations are managed by the cloud server 104. Functional code stored in the memory 206 may include program instructions to receive sensor information 208, program instructions to map sensor information with assets 210, program instructions to identify an anomaly 212, program instructions to simulate scenarios 214, and program instructions to notify operator 216.

The program instructions to receive sensor information and workforce information 208 may cause the processor 204 to receive sensor information from sensors installed at different locations in the warehouse. In one embodiment, the program instructions may retrieve workforce information from a WMS (Workforce Management System). The sensor information is related to events occurring within the warehouse in a real-time. The events are associated with performance of assets responsible for movement of articles at one or more locations in the warehouse. The workforce information may include information relating to the workforce of the enterprise such as the number of employees, specific skill set of each employee etc. The program instructions to map information with assets 210 may cause the processor 204 to map the sensor information and workforce information with assets present in the warehouse. The sensor information and workforce information may be mapped with the assets using a process model of the warehouse. The process model includes details of components, their connections, and their roles in performing different operations in the warehouse.

The program instructions 212 may cause the processor 204 to identify a first anomaly in an event. The first anomaly may be identified based on violation of predefined limits set for the sensor information related to the event. The predefined limits may be stored in a knowledge base. Similarly, the program instructions may cause the processor 204 to identify a second anomaly, wherein the second anomaly may be identified based on the violation of predefined limits or conditions stored in the knowledge base relating to workforce requirements. The program instructions 214 may cause the processor 204 to simulate scenarios relating to the one or more anomalies identified using the sensor information and workplace information, by referring to a knowledge base. The scenarios may be used for identification of effect of the one or more anomalies on the movement of the articles. The simulations may also be used for determining recommendations for mitigating the effect of the anomalies by identifying one or more bottleneck scenarios and/or optimal scenarios by correlation of simulated scenarios with real time data relating to the warehouse. The program instructions 216 may cause the processor 204 to notify an operator about the one or more recommendations.

By referring to the recommendations, the operator may take suitable actions for fixing the anomaly and thereby ensure smooth and continuous running of operations in the warehouse. Elaborative details of functioning of the program instructions 208 through 216 have been provided successively.

To provide the details of the anomaly and the one or more recommendations to the user device 112, the system 100 develops and utilizes a process model. The process model is a schema of all the assets operating in the warehouse and processes running in the warehouse. The process model includes configuration of assets, attributes, properties and IoT data source tag, and real-time calculation expressions.

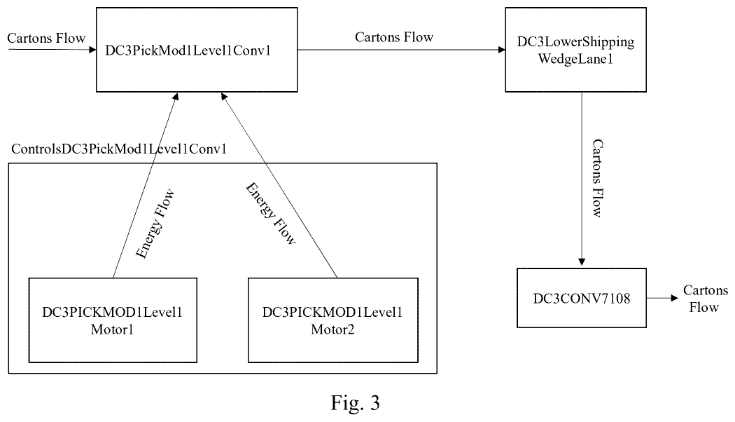

FIG. 3 illustrates a portion of the process model, in which movement path of cartons, different conveyors and motors responsible for operation of the conveyors are shown.

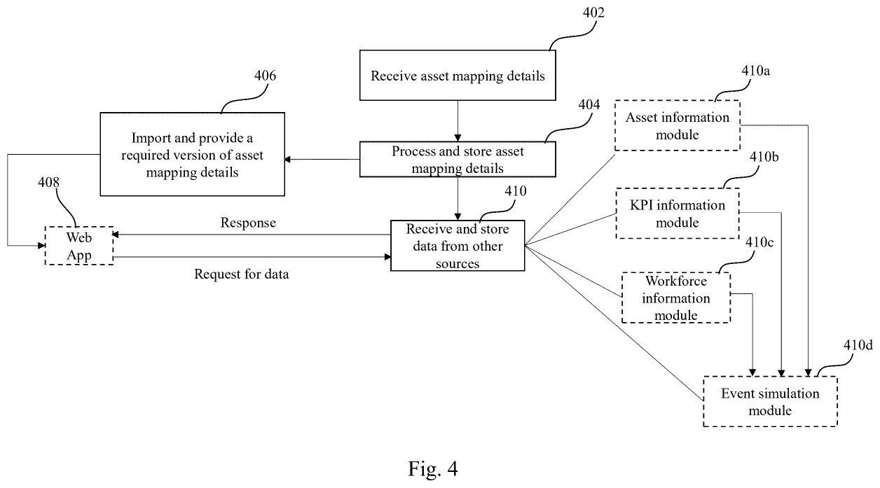

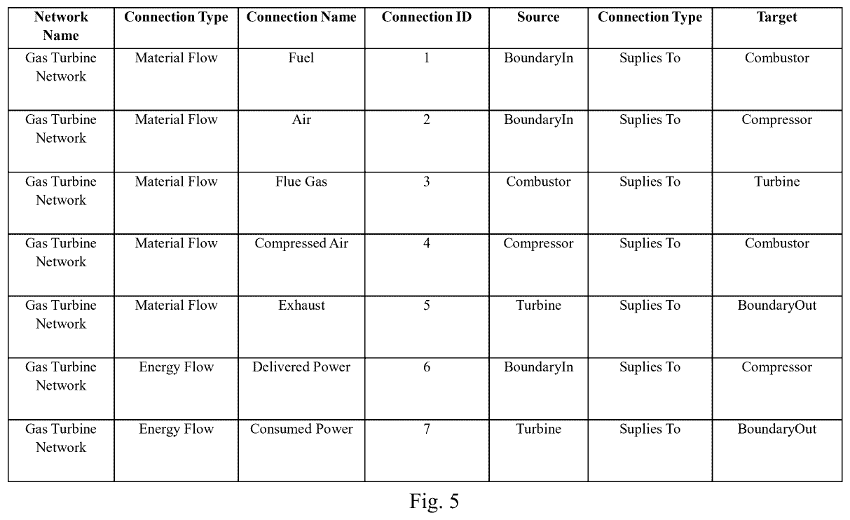

FIG. 4 illustrates a method of development of the process model, in accordance with an embodiment of the present disclosure. At step 402, the system 100 receives asset mapping details. As shown in FIG. 5, in one implementation, the asset mapping details include network names, connection types, connection names, connection identities, sources, and names of target elements. The asset mapping details may be obtained in a suitable data format, such as an Excel sheet, plain text file or Comma-Separated Values (CSV) file.

At step 404, the asset mapping details may be processed and then stored in a database in a suitable manner, such as a Structured Query Language (SQL) graph. The asset mapping details may include details of upstream assets and downstream assets and metrics and attributes associated with such assets, as illustrated in FIG. 5. It must be understood that in context of warehouses or supply chain, the terms upstream and downstream refer to different stages or processes involved in production and distribution of the articles. Such terms help describe flow of the articles and information within the supply chain.

Typically, the upstream assets refer to stages of the supply chain that are closer to beginning of production process. Activities performed by the upstream assets include procurement i.e. sourcing and acquiring of raw materials, components, and goods. The upstream assets may further perform production i.e. manufacturing or assembly activities where raw materials are transformed into finished goods. The upstream assets may further manage inbound logistics covering transportation, receiving, and storage of raw materials and components as they move towards production.

Typically, the downstream assets refer to the stages of the supply chain that are closer to end of the production process and closer to customers. Activities performed by the downstream assets include distribution and logistics i.e. transportation, storage, and delivery of finished goods to wholesalers, retailers, or directly to consumers. The downstream assets may handle outbound logistics i.e. manage movement of the finished goods from the production facility to distribution centers or retail locations.

At step 406, the operator 110 can import, using a web application 408, a required version of the asset mapping details. For example, a required version of the asset mapping details may be retrieved based on a location of an area of the warehouse where an operation is being managed by the operator 110. The operator 110 may visualize the asset mapping details over the web application 408.

At step 410, data may be obtained from other sources. In one implementation, the data may be obtained from an asset information module 410a, a Key Performance Indicator (KPI) information module 410b, a workforce information module 410c, and an event simulation module 410d. The asset information module 410a may provide details of assets and their attributes, and symptoms. The KPI information module 410b may provide KPI related data. The workforce information module 410c may provide details of individuals managing the assets in the warehouse, their skillset, work timings, etc. The event simulation module 410d may provide simulation data indicative of optimal and bottleneck scenarios (anomalies in movement of articles) and recommendations to mitigate the anomalies. The simulation data may be generated through processing of the data obtained from the modules 410a, 410b, and 410c.

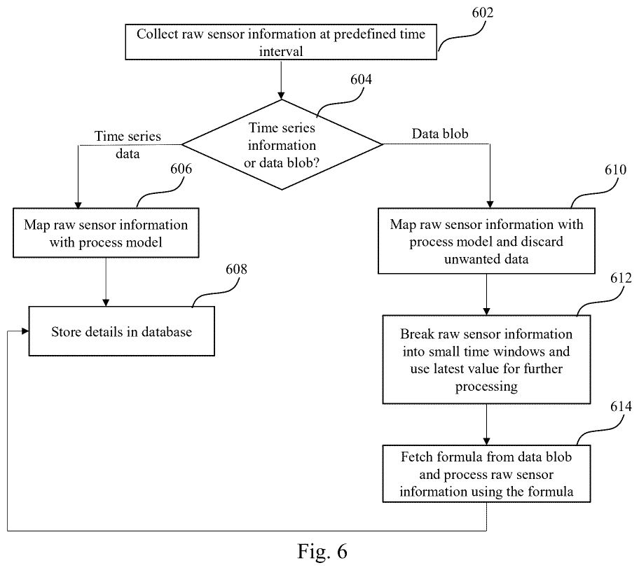

The data collected from one or more of the modules 410a, 410b, 410c, and 410d may be shown to the operator 110 over the web application 408 in response to a request for data received from the web application 408. The web application 408 may allow visualization of data in form of bar charts, line charts, pie charts, data tables, pivot tables, choropleth maps, bubble maps, heatmaps, tree diagrams, scatter plots, radar charts, 3D charts and models or process flows. The detailed method of operation and use of the modules 410a, 410b, 410c, and 410d are described successively with reference to FIG. 6.

FIG. 6 illustrates a flow chart of a method of pre-processing and storage of sensor information, in accordance with an embodiment of the present disclosure. At step 602, the gateway controller 106 may collect the sensor information at predefined time intervals, such as after every one minute or one second. At step 604, the sensor information is provided to an IoT layer for identifying if the sensor information is present as time-series data or as a data blob.

The time-series data is a type of data in which values are associated with specific timestamps or time intervals. Time-series data is particularly useful for analysing and understanding trends, patterns, and behaviours that evolve over time. A key characteristic of the time-series data includes temporal order i.e. the time series-data is ordered chronologically, with each data point associated with a specific time or time interval. The temporal order is crucial for understanding how values change over time. The time-series data can have various time intervals, such as seconds, minutes, hours, days, months, or years. The choice of the time interval depends on the nature of the data and analysis goals.

The data blob refers to a collection or cluster of data that is unstructured or lacks a defined format. More specifically, the data blob may refer to a mass or pile of data that may not have clear organization, schema, or standardized representation. For example, Binary Large Objects (BLOBs) may be the data blobs storing binary data, such as images, videos, or documents, and they may not be easily interpretable without specific applications or software.

At step 604, when it is determined that the sensor information is received as time series information, the sensor information is mapped with the process model, at step 606. Mapping of the sensor information with the process model helps in identifying the asset/hardware to which the sensor information corresponds. During the mapping of the sensor information with the process model, one or more of several parameters may be considered, such as data size, asset ID, location of the sensor providing the sensor information, and time of receiving the sensor information.

Upon identifying the asset, the sensor information along with details of the asset is stored in a database, for example within a new row in a time-series database, at step 608. Alternatively, at step 604, when it is determined that the sensor information is received as data blob, the sensor information is mapped with a process model for discarding unwanted data and keeping relevant data, at step 610. While mapping the sensor information with the process model, one or more data processing techniques may be utilized. For example, data pre-processing may be performed for removing noise, irrelevant characters, or artifacts that might hinder analysis. Further, textual data processing may be performed using Natural Language Processing (NLP) techniques. The NLP techniques may implement tokenization, part-of-speech tagging, and Named Entity Recognition (NER) for identifying key entities, relationships, and concepts within text.

In one implementation, machine learning models may be used for identifying the relevant data. For non-textual data blobs like images or audio, computer vision or audio processing techniques may be utilized. Convolutional Neural Networks (CNNs) can be applied to extract features from images, while techniques like spectrogram analysis can be used for audio data. Pattern recognition algorithms may be used for identifying recurring patterns, structures, or anomalies within the data blobs. Clustering algorithms or categorization techniques can be used for grouping similar data points together. This can help in identifying themes or commonalities within data. If available, metadata can be analysed for obtaining additional context or information about the data blobs, assisting in the identification of relevance.

Thereafter, the sensor information belonging to dependent or related assets is clustered. Details of the dependent assets are obtained from the process model and the sensor information belonging to the dependent assets is clustered. Simultaneously, a scheduler runs to trigger scheduled calculations at predefined time intervals upon receipt of a predefined amount of the sensor information.

Successively, the sensor information is broken into small time windows, such as for every one second, at step 612. A latest value of the sensor information present within a time window is used for further processing. Because the latest value of the sensor information is received as the data blob, at step 612, a corresponding formula is fetched and applied for processing the sensor information, at step 614. In some scenarios, dependent calculations may need to be performed in a predefined order. Executing the dependent calculations in the predefined order ensures that higher level calculations are provided to lower level calculations as inputs. Further, the sensor information may need to be processed in some scenarios, for filling missing values based on historical values. Post all such processing, the sensor information may be stored in the database, such as the time-series database.

The sensor information is continuously compared with threshold values for identification of a first anomaly (also referred as a hardware related anomaly). Specifically, higher and lower limits of values of the sensor information coming from each sensor is predefined by an operator based on an expected operation of the sensors and their past performances i.e. using historical data of the sensors. The sensor information is compared with respective predefined limits to determine whether the sensor information is present above or below the respective predefined limits. A violation of the predefined limits may indicate the hardware related anomaly in an event performed by an asset. For example, the hardware related anomaly may be slow operation of a conveyor motor driving a conveyor belt for transfer of articles. Details of the hardware related anomaly may be stored in the database for future reference. Further, the operator 110 may be notified about the hardware related anomaly so that an appropriate action is taken.

Such anomalies may include, but not limited to, barcode scanner malfunctions, RFID reader problems, label printer failures, wired or wireless network issues, forklift sensor failures, conveyor belt breakdowns, pallet racking damage, Automated Guided Vehicle (AGV) problems, voice-picking system issues, Warehouse Management System (WMS) hardware failures, climate control system breakdowns, dock door malfunctions, security system failures, handheld device problems, automated sorting system breakdowns, power supply interruptions, pick-to-light system issues, dust and debris accumulation, and battery failures in equipment.

The operator 110 may be notified about the hardware related anomaly based on notification preferences of the operator 110. The notification preferences may be stored in a database and include details of one or more sites of the warehouse, categories of assets, notification frequency, mode of notification, severity details for which the operator 110 is interested in obtaining notifications. The notification preferences may include a mode of obtaining the notifications, such as mail, text message, messenger ping, or system generated call. For anomalies of different severities, the operator 110 may also define the notification frequency, such as after every 15 minutes, 30 minutes, and 1 hour.

The system 100 may utilize workforce information for determining a second anomaly in the event. The second anomaly may be associated with the first anomaly i.e. the hardware related anomaly or may be completely different. The workforce information may be obtained from a Workforce Management System (WMS), a Labor Management System (LMS) or a Computerized Maintenance Management System (CMMS). The WMS, LMS, CMMS, and other such systems and databases may be proprietary or owned by one or more third parties.

The workforce information may also include details of employee demographics, such as name, age, gender, ethnicity, and contact information (address, phone number, email). The workforce information may also include details of employment history, such as start date, end date (of any previous employee), duration of employment, job titles and positions held, and work locations and departments. The workforce information may also include details of educational background, such as educational institutions attended, academic qualifications, and degrees earned. The workforce information may further include details of skills and competencies, such as technical and soft skills possessed by the employees and certifications and training completed. The workforce information may also include details of employee performance and ratings. The workforce information may further include details of work hours and attendance, such as regular work hours, overtime records, attendance and leave records.

The workforce information may be continuously compared with threshold values for identification of the second anomaly (alternatively referred as a workforce related anomaly). The threshold values may be a maximum and a minimum number of individuals, skills of the individuals that should be assigned to take care of an operation. Upon comparison of the workforce information with the threshold values, the workforce related anomaly may be identified. The workforce related anomaly may correspond to shortage or lack of skilled individuals designated for handling the event. For example, the workforce related anomaly may indicate absence of a skilled individual for checking a fault in the conveyor belt.

The system 100 may determine the effect of the hardware related anomaly and workforce related anomaly by simulating a plurality of scenarios based on the sensor information and knowledge information. In one embodiment of the present invention, the knowledge base may be a Discrete Event Simulation (DES), and the system 100 may utilize a DES model of the warehouse to simulate the plurality of scenarios based on the sensor information and the workforce information.

The DES model may be created using asset to asset mapping visualization details present in the process model. The DES model may represent physical layout, assets, material flow, and logics governing different operations in the warehouse. The DES model also includes details of events and activities occurring in the warehouse, such as arrivals of goods, cartons overflow, misreads of goods, maintenance tasks, and machine faults. The DES model may be calibrated and validated before use. The DES model may be calibrated using historical data to ensure accurate reflection of the operations performed in the warehouse. The DES model may be validated by comparing its output with historical performance and Key Performance Indicators (KPIs).

With respect to the hardware related anomaly, in one scenario, from simulation results obtained using the DES model, when it is determined that a conveyor belt is working at 50% speed, the system 100 may identify the different processes in the warehouse that are dependent on the operation of the conveyor belt. In one case, the system 100 may identify, by referring to the DES model, that the conveyor belt is responsible for sorting of articles in the warehouse, and transferring them to different areas of the warehouse for storage. With such information, the system 100 determines that the sorting and storing operation in the warehouse will get reduced to half of its usual capacity if the hardware related anomaly associated with the conveyor belt is not addressed.

The system 100 may further identify, using the DES model, the different reasons that might be associated with the hardware related anomaly i.e. the slow operation of the conveyor belt in above case. In one scenario, the system 100 may determine that the slow operation of the conveyor belt is caused due to low power supply to the motor of the conveyor belt, ingress of contaminants like dust in the motor, overloading of the conveyor belt with the articles or malfunction of scanner used for sorting of the articles on the conveyor belt.

Similarly, with respect to workforce related anomaly, the system 100 may determine the effect of the workforce related anomaly by simulating a plurality of scenarios, using the workforce information. The system 100 may simulate the plurality of scenarios based on the DES model. For example, when absence of the skilled individual for checking the faulty conveyor belt is identified, the system 100 may identify the different processes in the warehouse that are dependent on the operation of the conveyor belt. In one case, the system 100 may identify, using the DES model, that the conveyor belt is responsible for sorting of articles in the warehouse, and transferring them to different areas of the warehouse for storage. With such information, the system 100 determines that the sorting and storing operation in the warehouse will get reduced to half of its usual capacity if the workforce related anomaly associated with the conveyor belt is not addressed.

Hence, in certain embodiments of the present invention, the DES model is used for generating the plurality of scenarios relating to hardware related anomalies and/or workforce related anomalies identified by the system 100. The system 100 may thereafter provide recommendations to the operator 110 over a User Interface (UI) for mitigating the effects of the anomalies determined. With usage of the DES model, the system 100 may not only provide the recommendations for mitigating the anomalies but also provide recommendations for making changes and improvements in operations of the warehouse. The system 100 may provide a comprehensive report outlining recommended changes, potential impacts on KPIs, and a cost-benefit analysis. The recommended changes could be made into the process model and the DES model and a sensitivity analysis may be performed to understand how changes in specific parameters would affect the operations of the warehouse. In this manner, robustness of the recommendations can be assessed and uncertainty in real-world conditions can be accounted

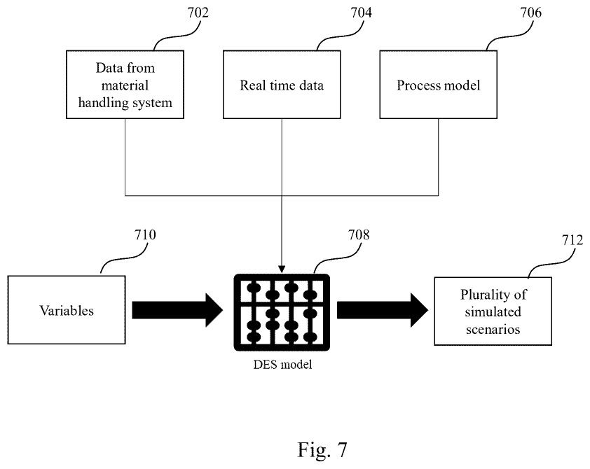

FIG. 7 illustrates a system for generating a plurality of simulated scenarios based on a DES model, in accordance with an embodiment of the present invention. The DES model is trained based on data provided by the material handling system 702, real time data 704, and based on output of process model 706. The data provided by the material handling system would include data relating to the warehouse and its operations, historical data relating to the different processes performed in the warehouse etc. The real time data 704 includes real time data obtained from the plurality of sensors used within the warehouse, and real time data from conveyors, scanners, and workers. The output from the process model 706 used for training or developing of the DES model 708 includes information such as the asset to asset mapping created by the process model, based on which information relating to assets associated or related to an asset may be obtained.

Based on such input data and information, the Discrete Event Simulation (DES) model 708 is trained, and the DES model 708 is used to generate a plurality of simulated scenarios corresponding to first anomalies and/or second anomalies identified by the system 100, wherein the first anomalies relate to hardware related anomalies and second anomalies related to workforce anomalies. The plurality of simulated scenarios corresponding to such anomalies are generated by the DES model 708 based on different possible values of variables 710 provided as input, wherein the variables 710 include factors impacting the first and second anomalies such as number of workers, worker productivity, carton frequency, carton dimensions, conveyer speed, and conveyer condition. The DES model 708 generates a plurality of simulated scenarios 712 as output, and each scenario generated corresponds to a specific set of values of the variables 710. Hence, a new scenario may be simulated by the DES model 708 corresponding to change in value of a single variable.

The plurality of simulated scenarios 712 generated by the DES model 708 provides insight into the possible effects of hardware anomalies, workforce anomalies, or a combination of both hardware and workforce anomalies. In certain embodiments, the system 100 may perform correlation of the simulated scenarios with the real time data, and such correlation is performed to identify actual scenarios that are likely to arise as an effect of the hardware and/or workforce anomalies. Based on such determination of actual scenarios, the system 100 may further generate recommendations that mitigate or address such actual scenarios.

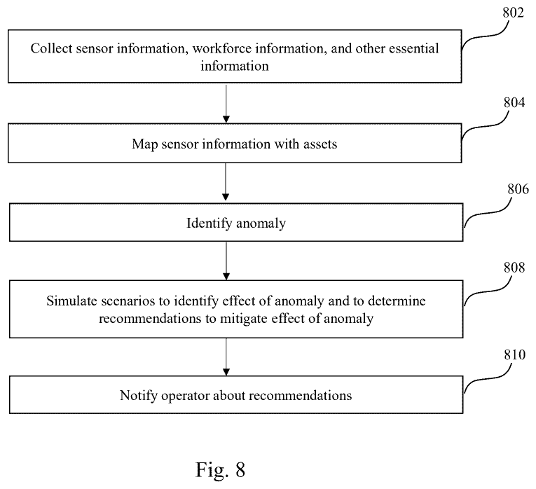

Referring now to FIG. 8, the steps for simulating a plurality of scenarios occurring in a warehouse corresponding to anomalies is described. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 8 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

At block 802, sensor information, workforce information, and other essential information, such as KPI metrices may be obtained. The sensor information may be received from sensors installed at different locations in the warehouse. The sensor information may be related to events occurring within the warehouse in a real-time. The events may be associated with performance of assets responsible for movement of articles at one or more locations in the warehouse. The workforce information may include details of individuals designated for handling all the events in the warehouse.

At block 804, the sensor information may be mapped with assets present in the warehouse. The sensor information may be mapped with the assets using a process model of the warehouse. The process model may include details of components, their connections, and their roles in performing different operations in the warehouse.

At block 806, an anomaly may be identified. The anomaly may be a hardware related anomaly or a workforce related anomaly. The hardware related anomaly may be determined based on violation of predefined limits set for the sensor information related to the event. The workforce related anomaly is associated with shortage or lack of skilled individuals designated for handling the event.

At block 808, scenarios may be simulated to identify effect of the anomaly and to determine recommendations to mitigate effect of the anomaly. The scenarios may be simulated for example, based on the sensor information, by referring to a knowledge base.

At block 810, an operator may be notified of the recommendations. In one case, the recommendations may include instructions for taking one more actions for fixing the hardware related anomaly. In another case, the recommendations may include details of skilled individuals identified for performing one or more tasks for addressing the workforce related anomaly.

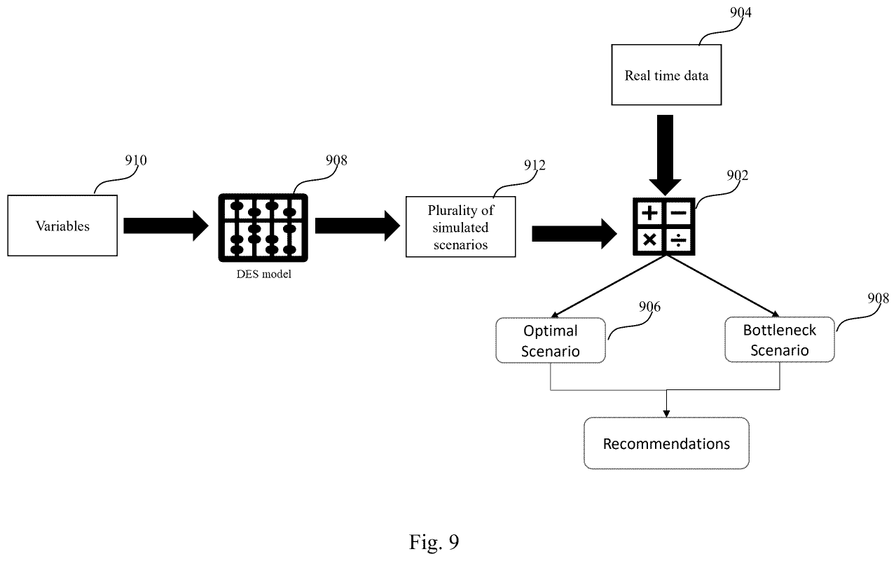

FIG. 9 illustrates the correlation of the plurality of simulated scenarios with real time date for determining recommendations, in accordance with an embodiment of the present invention. The plurality of simulated scenarios 912 generated by the DES model 908 based on different values of variables 910 reflects the possible effects of different hardware and/or workforce anomalies on the functioning of the warehouse. Hence the plurality of simulated scenarios 912 represent the range of possible outcomes of anomalies, and the scenarios that are likely to occur based on real time data of the warehouse is obtained by correlating 904 the plurality of simulated scenarios with real time data obtained from sources such as sensors, scanners, and databases for storing real time information on the different assets and workforce of the warehouse. The scenarios likely to occur based on correlation with real time data may be of two types, and these types are optimal scenarios 906 or bottleneck scenarios 908. Optimal scenarios 906 refer to all such scenarios wherein the performance or outcome of the process/operation of warehouse is optimal, and is not likely to cause bottleneck or drop in efficiency in future. Contrastingly, bottleneck scenarios 908 include scenarios wherein the performance or operation of a process in the warehouse is sub-optimal or likely to cause bottleneck if not rectified.

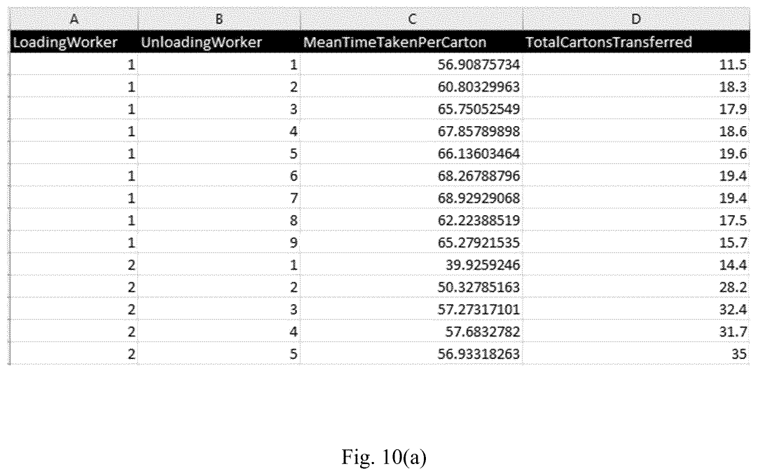

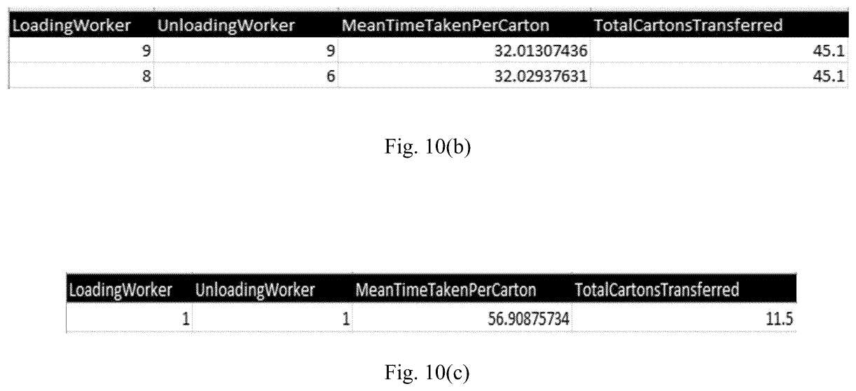

FIGS. 10(a), 10(b), and 10(c) illustrate tabular data relating to an exemplary implementation of the system 100 for identifying optimal and bottleneck scenarios, in accordance with an embodiment of the present invention. FIG. 10(a) depicts the plurality of simulated scenarios generated corresponding to different values of two variables ‘LoadingWorker’ and ‘UnloadingWorker’, and the simulated scenarios are represented with respect to desired variables such as time taken per carton from loading to unloading, and total number of cartons transferred. FIG. 10(b) illustrates two highly optimal scenarios that are identified when real time data indicates that number of loading workers and unloading workers are 9 and 9 respectively at one instant, and 8 and 6 respectively at another instant. FIG. 10(c) illustrates a bottleneck scenario identified when real time data indicates that number of loading worker and number of unloading worker is 1. It can be observed that an indication of the optimal and sub-optimal performance corresponding to an optimal and bottleneck scenario is obtained from the values of the output variables “MeanTimeTakenPerCarton” and “TotalCartonsTransferred”. Recommendations may be generated by the system 100 corresponding to the identified optimal and/or bottleneck scenarios.

Corresponding to both optimal scenarios 906 and bottleneck scenarios 908 identified by the system 100, the recommendations may be generated so as to improve the overall performance or productivity of the operations of the warehouse. Specifically, in an exemplary embodiment, if optimal scenarios 906 are identified, the recommendations provided by the system 100 to an operator 110 may include suggestion to maintain variables as per the current status, or may also include recommendation to reduce resources currently allotted to analyze whether resources can be further minimized without impacting performance, wherein resources refer to both hardware and workforce resources. The removal of resources may be beneficial to the productivity of operations of the warehouse, as such resources may be allotted to other operations or processes that need the resources. Similarly, in an exemplary embodiment of the present invention, the recommendation with respect to one or more bottleneck scenarios 908 identified may include instructions as to how existing resources as to be managed, or regarding the additional resources that could be allocated to avoid the bottleneck scenarios 908.

In an embodiment of the present invention, the historical data relating to the different operations performed in the warehouse, the variables utilized therein, and the corresponding effectiveness or performance may be used by the system 100 for generating recommendations to mitigate bottleneck scenarios 908 that are identified or already occurred. Such recommendations may be based on steps or actions taken to address a similar bottleneck scenario with similar variable values.

For example, to address the fault of the conveyor belt, the system 100 may identify an individual skilled in repairing faulty conveyor belts, and provide details of such individual to the operator 110 so that the individual may be assigned to quickly address the fault of the conveyor belt.

The system 100 may also offer visualization of details of anomalies and the recommendations to the operator 110 over a User Interface (UI), such as a web page or a mobile application. The details may be accessed by the operator based on his access rights. Each operator working in the warehouse may have different access rights based on work shift hours, location of work, nature of work, and position. Based on the access rights, the operator may receive the recommendations, in an audio or visual form, and accordingly take suitable actions.

In one scenario, a recommendation may be provided to a supervisor to allocate a greater number of operators or a skilled operator to address an anomaly. The supervisor may receive such recommendation over a desktop or a smartphone operated by him. Further, the recommendation may be provided as a mail, message, or automated system call. The supervisor may approve and forward the mail, message, or automated system call to respective operator(s). Alternatively, the system 100 may itself identify the skilled operator required to address the anomaly, by referring to the workforce information, and send a notification to such skilled operator to address the anomaly.

In a manner described above, the system 100 may identify and provide recommendations for mitigating the effect of several other anomalies. Such anomalies may include, but not limited to, labor shortages, inadequate training of workforce, health and safety concerns, fatigue and burnout, communication challenges, mismatched skills and job roles, employee disengagement, conflict among team members, absence and tardiness, and technology integration challenges.

The types of recommendations that may be provided by the system 100 based on identification of optimal scenarios 906 and/or bottleneck scenarios 908 include recommendations for such scenarios corresponding to an asset that is going to be affected, or an asset already affected.

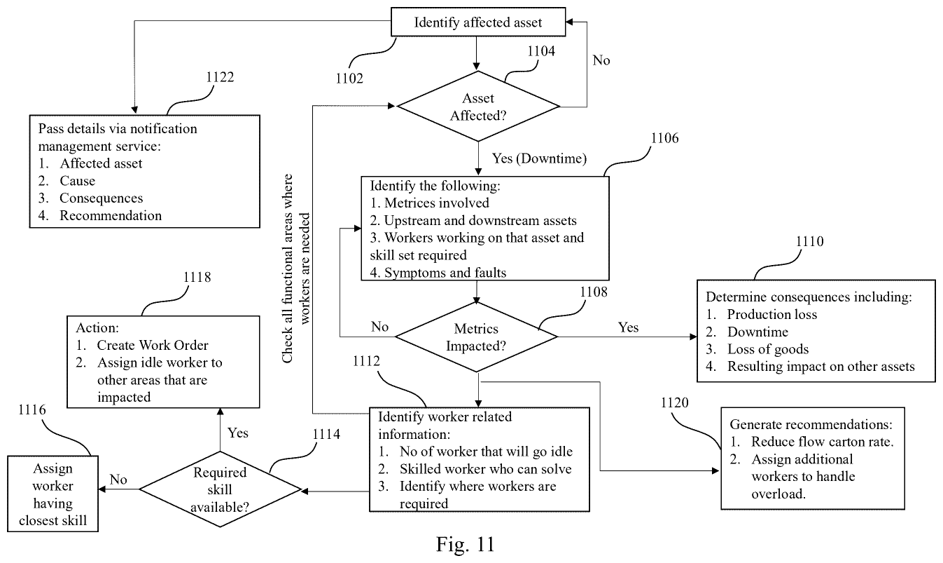

Referring now to FIG. 11, a method of managing operations in a warehouse when an asset is already affected is described. At step 1102, a background process runs continuously to identify if any asset is affected. At step 1104, when no asset is identified to be affected, control is transferred back to the background process to identify any affected asset. Alternatively, when an asset is identified to be affected, at step 1102, metric involved may be determined, upstream assets and downstream assets associated with the affected asset are identified, workers working on the affected asset are identified, and symptoms and faults associated with the affected asset are identified, at step 1106.

Successively, at step 1108, it is determined if any metric is impacted due to the affected asset. When a metric is identified to be impacted, its consequences are determined, at step 1110. The consequences include production loss in monetary terms, downtime, loss of goods, and resulting impact on other assets. Also, worker related information is also determined, at step 1112. The worker related information includes number of workers that will go idle, details of skilled workers who can rectify fault of the affected asset, and locations where more workers are required. Additionally, all areas of the warehouse where workers are needed are checked, and status of any affected asset is again determined. Based on the worker related information, it is determined if required skill for handling the affected asset is available or not, at step 1114. When the required skill is identified to be not available, a worker having a skillset closest to the required skill is assigned to handle the asset, at step 1116. Alternatively, when the required skill is identified to be available, suitable actions are determined, at step 1118. Specifically, a work order is created and idle workers are assigned to other areas of the warehouse that are impacted, for example a picking area.

Thereafter, recommendations are generated by running different scenario based simulations using DES model and correlating with real time data, at step 1120. For example, reductions in flow carton rate on a conveyor belt could be determined. Additionally or alternatively, assignment of more workers to the conveyor belt may be determined for handling overload condition. Finally, all the details are provided to a supervisor, via a notification management service, for addressing issue associated with the affected asset, at step 1122. Such details may include specifics of the affected asset, cause of affect, consequences of the affect, and the recommendations.

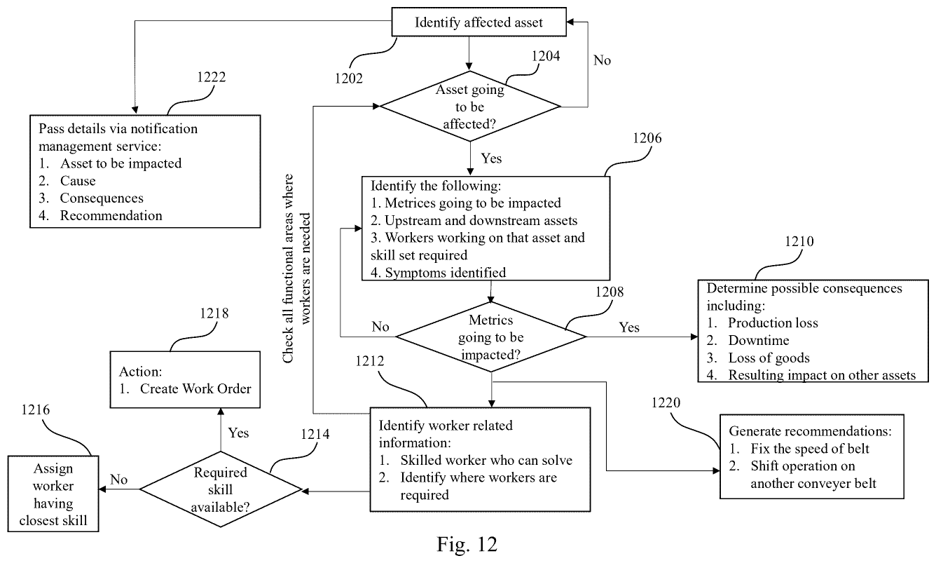

Referring now to FIG. 12, a method of managing operations in a warehouse when an asset is going to be affected is described. At step 1202, a background process runs continuously to identify if any asset is affected. At step 1204, when it is identified that no asset is going to be affected, control is transferred back to the background process to identify any affected asset. Alternatively, at step 1202, when it is identified that an asset is going to be affected, metric going to be impacted is identified, upstream assets and downstream assets associated with the asset going to be impacted are identified, workers working on the asset going to be impacted are identified, and symptoms associated with the asset going to be impacted are identified, at step 1206.

Successively, at step 1208, it is determined if any metric is going to be impacted after the asset is affected. When a metric going to be impacted is identified, possible consequences are determined, at step 1210. The possible consequences include production loss in monetary terms, downtime, loss of goods, and resulting impact on other assets. Also, worker related information is also determined, at step 1212. The worker related information includes details of skilled workers who can rectify fault of the asset when affected and locations where more workers are required. Additionally, all areas of the warehouse where workers are needed are checked, and status of any affected asset is again determined. Based on the worker related information, it is determined if required skill for handling the affected asset is available or not, at step 1214. When the required skill is identified to be not available, a worker having a skillset closest to the required skill is assigned to handle the asset, at step 1216. Alternatively, when the required skill is identified to be available, suitable actions are determined, at step 1218. Specifically, a work order is created.

Thereafter, recommendations are generated by running different scenario based simulations generated by DES model and correlating the simulations with the real time data, at step 1220. For example, fixing of speed of a conveyor belt could be determined. Additionally, or alternatively, shifting of operation on another conveyor belt may be determined. Finally, all the details are provided to a supervisor, via a notification management service, for addressing issue associated with the affected asset, at step 1222. Such details may include specifics of the asset going to be impacted, cause of affect, consequences of the affect, and the recommendations.

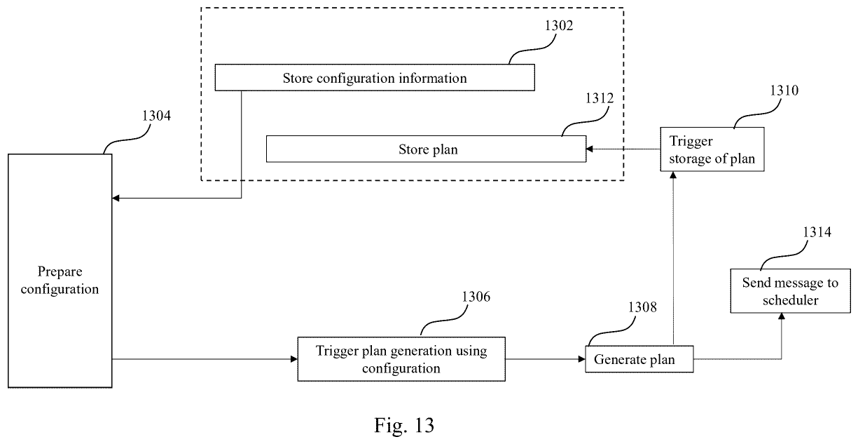

In addition to providing recommendations to an operator 110 based on existing or potential hardware anomaly, workforce anomaly, or failure of assets, the system 100 may also be used for planning operations of a warehouse. Referring now to FIG. 13, a method of planning operations of a warehouse is described. At step 1302, configuration information related to metrics is stored at a storage location, for example the cloud server 104. The configuration information is later used for preparing the DES model. The configuration information refers to relevant information to be used for preparing configurations. At step 1304, the configurations are prepared using the configuration information. The configurations may include metric group configurations. A snippet of example metric group configurations is provided below.
Data: [
{
“name”: “AssetDetailKPI”,
“MetricConfig”: [{
“name”: “Performance”,
“Target”: “ ”,
“unitName”: “ ”

The configurations may further include asset metric mapping configurations. A snippet of example asset metric mapping configurations is provided below.
Data: [
{
“AssetName”: “ ”,
MetricsInfo: [
MetricName: “Metric1”,
MetricName: “Metric1”,
}]

The subroutine MetricInfo used above includes metric related information like properties, source, dependents etc.

At step 1306, a plan generation using the configurations is triggered. At step 1308, the plan is generated. The plan identifies dependencies across the KPIs and across assets. The plan is made for ProcessGroups and UnitOfWork (UoW) based on the configuration. At step 1310, storage of the plan is triggered. At step 1312, the plan is stored at a storage location, such as the cloud server 104. The plan is stored with ProcessGroups and UnitOfWork. The plan is utilized for parallel execution of metric calculations related to the assets, for example UoW1 and UoW2. At step 1314, a message is sent to a scheduler 1400 to notify operators about the plan.

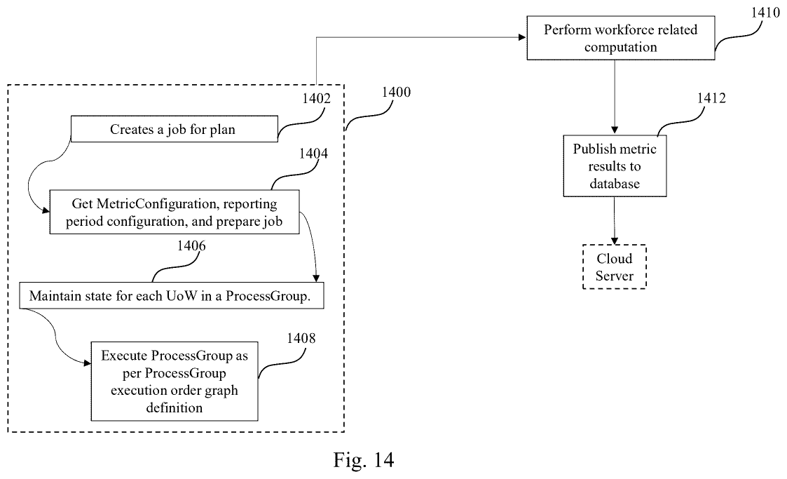

Referring now to FIG. 14, a process of creating and implementing a job is described. At step 1402, the scheduler 1400 creates a job corresponding to the plan. The job may be executed for a predefined time period. At step 1404, configurations of the metric i.e. MetricConfig may be obtained. Also, reporting period configuration may be obtained. A job may be prepared for an operator based on the MetricConfig and the reporting period configuration. At step 1406, a state is maintained for each UoW in a ProcessGroup. At step 1408, each ProcessGroup is executed as per definitions present in a ProcessGroup execution order graph.

At step 1410, workforce related computation is performed. The workforce related computation includes performing metric aggregation of all the MetricConfig received for the predefined time period. The workforce related computation may further include bringing rollup data in a hierarchy, identifying the second anomaly i.e. the workforce related anomaly or executing custom functions. The workforce related anomaly may be determined by comparing the prestored workforce information with workforce information corresponding to a newly created job.

At step 1412, metric results determined through metric aggregation and other details obtained through the workforce related computation are stored in a database, such as the cloud server.

By implementing the above described methodology, the proposed system is able to provide one or more technical advantages mentioned successively. The system enables utilization of real-time sensor information of machines operating in a warehouse for managing the undesired events i.e. anomalies in a real-time. Further, data from other sources, such as Workforce Management system (WMS), Labor Management System (LMS), and Computerized Maintenance Management System (CMMS) is also utilized for identifying the anomalies in the real-time. The anomalies may be associated with resource utilization, queue lengths, and idle time for various assets. Based on analysis of data obtained from all the sources, the system identifies the anomalies and determines suitable recommendations for fixing the anomalies. Further, the system provides, to the customers, real-time insights of operations being performed in the warehouse, deviations or anomalies in usual operations, and the ways to fix the anomalies.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

A computer network may be implemented using wired and/or wireless communication technologies. The computer network may comprise various network components such as switches, Provide Edge (PE) routers, Customer Edge (CE) routers, intermediate routers, bridges, computers, servers, and the like. The network devices present in the computer network may implement an Interior Gateway Protocol (IGP) including, but not limited to, Open Shortest Path First (OSPF), Routing Information Protocol (RIP), Intermediate System to Intermediate System (IS-IS), and Enhanced Interior Gateway Routing Protocol (EIGRP).

An interface may be used to provide input or fetch output from the system. The interface may be implemented as a Command Line Interface (CLI), Graphical User Interface (GUI). Further, Application Programming Interfaces (APIs) may also be used for remotely interacting with edge systems and cloud servers.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms operator, person, employee, worker, labor, personnel, workforce, supervisor, and manager have been used interchangeably throughout the draft and corresponds to an individual working in a warehouse or directly or indirectly managing operations in the warehouse.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

What is claimed is:

1. A method of managing operations in a warehouse, the method comprising:
receiving, from sensors installed at one or more locations in the warehouse, sensor information related to events occurring within the warehouse in a real-time, wherein the events are associated with performance of assets responsible for movement of articles at one or more locations in the warehouse;
mapping, by a processor, the sensor information with one or more assets present in the warehouse, using a process model of the warehouse;
identifying, by the processor, at least one anomaly in an event, based on violation of predefined limits set for the sensor information related to the event;
simulating, by the processor, a plurality of scenarios, based on the sensor information, to identify effect of the anomaly on the movement of the articles, said plurality of scenarios includes at least an optimal scenario or a bottleneck scenario;
determine one or more recommendations based on identified scenario for mitigating the effect of the anomaly, wherein the plurality of scenarios is simulated by referring to a knowledge base; and
notifying, by the processor, an operator about the one or more recommendations.

2. The method of claim 1, further comprising utilizing workforce information for identifying the anomaly in the event,
wherein the workforce information includes details of individuals designated for handling all the events in the warehouse, and
the anomaly is associated with shortage or lack of skilled individuals designated for handling the event.

3. The method of claim 2, further comprising identifying the skilled individuals from the workforce information, based on availability and skill set, for performing one or more tasks specified in the one or more recommendations.

4. The method of claim 1, wherein the sensor information is obtained as time-series data or as data blobs.

5. The method of claim 1, further comprising utilizing historical data for simulating the plurality of scenarios.

6. The method of claim 1, further comprising triggering scheduled calculations at predefined time intervals upon receipt of a predefined amount of the sensor information.

7. The method of claim 1, further comprising allowing the operator to define a mode of communication, warehouse site, frequency, severity, and category of the events for receiving notifications related to anomalies and recommendations.

8. The method of claim 1, further comprising clustering the sensor information of dependent assets for simulating the plurality of scenarios.

9. The method of claim 1, further comprising utilizing an output of computation of a higher level event for performing computation of a lower level event associated with the higher level event, for simulating the plurality of scenarios.

10. A system comprising:
a processor;
a memory storing program instructions which, when executed by the processor, causes the processor to:
receive, from sensors installed at one or more locations in the warehouse, sensor information related to events occurring within the warehouse in a real-time, wherein the events are associated with performance of assets responsible for movement of articles at one or more locations in the warehouse;
map the sensor information with one or more assets present in the warehouse, using a process model of the warehouse;
identify at least one anomaly in an event, based on violation of predefined limits set for the sensor information related to the event;
simulate a plurality of scenarios, based on the sensor information, to identify effect of the anomaly on the movement of the articles, said plurality of scenarios includes at least an optimal scenario or a bottleneck scenario;
determine one or more recommendations based on identified scenario for mitigating the effect of the anomaly, wherein the plurality of scenarios is simulated by referring to a knowledge base; and
notify an operator about the one or more recommendations.

11. The system of claim 10, further comprising program instructions causing the processor to utilize workforce information for identifying the anomaly in the event,
wherein the workforce information includes details of individuals designated for handling all the events in the warehouse, and
the anomaly is associated with shortage or lack of skilled individuals designated for handling the event.

12. The system of claim 11, further comprising program instructions causing the processor to identify the skilled individuals from the workforce information, based on availability and skill set, for performing one or more tasks specified in the one or more recommendations.

13. The system of claim 10, wherein the sensor information is obtained as time-series data or as data blobs.

14. The system of claim 10, further comprising program instructions causing the processor to utilize historical data for simulating the plurality of scenarios.

15. The system of claim 10, further comprising program instructions causing the processor to trigger scheduled calculations at predefined time intervals upon receipt of a predefined amount of the sensor information.

16. The system of claim 10, further comprising program instructions causing the processor to allow the operator to define a mode of communication, warehouse site, frequency, severity, and category of the events for receiving notifications related to anomalies and recommendations.

17. The system of claim 10, further comprising program instructions causing the processor to cluster the sensor information of dependent assets for simulating the plurality of scenarios.

18. The system of claim 10, further comprising program instructions causing the processor to utilize an output of computation of a higher level event for performing computation of a lower level event associated with the higher level event, for simulating the plurality of scenarios.

19. A non-transitory computer-readable storage medium storing program instructions for managing operations in a warehouse, the instructions, when executed, perform the steps of:
receiving, from sensors installed at one or more locations in the warehouse, sensor information related to events occurring within the warehouse in a real-time, wherein the events are associated with performance of assets responsible for movement of articles at one or more locations in the warehouse;
mapping the sensor information with one or more assets present in the warehouse, using a process model of the warehouse;
identifying at least one anomaly in an event, based on violation of predefined limits set for the sensor information related to the event;
simulating a plurality of scenarios, based on the sensor information, to identify effect of the anomaly on the movement of the articles, said plurality of scenarios includes at least an optimal scenario or a bottleneck scenario;
determining one or more recommendations based on identified scenario for mitigating the effect of the anomaly, wherein the plurality of scenarios is simulated by referring to a knowledge base; and
notifying an operator about the one or more recommendations.

20. The non-transitory computer-readable storage medium of claim 19, further comprising program instructions to perform the steps of:
utilizing workforce information for identifying the anomaly in the event, wherein the workforce information includes details of individuals designated for handling all the events in the warehouse, and the anomaly is associated with shortage or lack of skilled individuals designated for handling the event; and
identifying the skilled individuals from the workforce information, based on availability and skill set, for performing one or more tasks specified in the one or more recommendations.
